(19) United States
(12) Patent Application Publication
(10) Pub. No.: US 2016/0082345 A1
(43) Pub. Date: Mar. 24, 2016

(54) Crane Controller Method and PCB

(71) Applicants: Gary Balaban, Old Bridge, NJ (US); John Maurer, Whitehouse Stations, NJ (US)

(72) Inventors: Gary Balaban, Old Bridge, NJ (US); John Maurer, Whitehouse Stations, NJ (US)

(21) Appl. No.: 14/867,068

(22) Filed: Sep. 28, 2015

Related U.S. Application Data
(63) Continuation of application No. 13/358,915, filed on Jan. 26, 2012, now abandoned.
(60) Provisional application No. 61/436,458, filed on Jan. 26, 2011.

(51) Int. Cl. A63F 9/30; G07F 17/32; A63F 9/24

(52) U.S. Cl. CPC A63F 9/30; A63F 9/24; G07F 17/3297; G07F 17/3223; G07F 17/3218; G07F 17/3209; G07F 17/3227; A63F 2009/2488; A63F 2009/2407; A63F 2009/2491

(57) ABSTRACT

A controller provides a GUI for accessing a PCB. The controller is used to retrieve information from the controller PCB and to also program other information into it as well as perform diagnostics of the game and machine. The owner of the crane machine can place an object in the crane's claw and then enter a setup mode using the PCB. The game will then proceed to, based on an algorithm, make its own adjustments to properly set the strength of the crane's claw to have the game play properly. The controller is equipped with a wireless access point to allow the owner to remotely access and control all of the same functions as from the controller. An owner is able to program the value of the prize in the game along with the desired amount of money to be collected, to maintain a profitable win ratio.

### CROSS REFERENCE TO RELATED APPLICATIONS

This application is a continuation patent application of (CPA) and claims priority from U.S. patent application Ser. No. 13/358,915, entitled “Crane Controller Method and PCB”, filed on 26 Jan. 2012. The benefit under 35 USC §119(e) of the United States provisional application is hereby claimed, and the aforementioned application is hereby incorporated herein by reference.

U.S. Ser. No. 13/358,915 claims priority from U.S. Patent Application Ser. No. 61/436,458, entitled “Crane Controller Method and PCB”, filed on 26 Jan. 2011. The benefit under 35 USC §119(e) of the United States provisional application is hereby claimed, and the aforementioned application is hereby incorporated herein by reference.

### TECHNICAL FIELD OF THE INVENTION

The present invention relates generally to a crane game. More specifically, the present invention relates to a crane game featuring an electronic circuit board controller to properly set the strength of the crane's claw to ensure the game play is proper.

### BACKGROUND OF THE INVENTION

Many crane machines are know in the prior art. In the current state of the prior art the owner of a machine must manually set up the proper strength of the claw to have the game play properly. The present invention allows the owner of the crane machine to place an object in the crane's claw and then enter a setup mode using a PCB. The game will then proceed to, based on an algorithm, make its own adjustments to properly set the strength of the crane's claw to have the game play properly.

Previously, this same adjustment has been done entirely manually by the owner of the game by basically a series of trial and error adjustments with two variable potentiometers. The present invention takes the guesswork out of this critical adjustment and saves the owner time and money.

### SUMMARY OF THE INVENTION

The present invention allows the owner of the crane machine to place an object in the crane's claw and then enter a setup mode using a PCB. The game will then proceed to, based on an algorithm, make its own adjustments to properly set the strength of the crane's claw to have the game play properly.

A Hand Held Controller provides a graphical user interface (GUI) for accessing the printed circuit board (PCB). The Hand Held Controller Wand is used to retrieve information from the controller PCB and to also program other information into it as well as perform diagnostics of the game and machine.

In an other embodiment, remote access to the controller via the Internet is taught. The controller is equipped with a wireless access point to allow the owner to remotely, over the Internet, to access and control all of the same functions as from the Hand Held Controller GUI from a PC, BLACKBERRY, IPHONE device, or other electronic device with Internet access.

An owner is able to program the value of the prize in the game along with the desired amount of money to be collected, on average, to maintain a profitable win ratio. Status LEDs on the controller are provided to assist in diagnostics and status of physical parts of the game itself.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 is a flow chart illustrating the method of controlling a crane game and PCB as taught by the present invention;

FIG. 2a illustrates the first/title screen of the controller GUI and the setup mode;

FIG. 2b illustrates the game counters menus as shown on the controller GUI;

FIG. 3 is a flow chart illustrating the game counter method of control as taught by the present invention;

FIG. 4 is a flow chart illustrating the test menu method of control as taught by the present invention;

FIG. 5 is a flow chart illustrating the cash options method of control as taught by the present invention;

FIG. 6 is a flow chart illustrating the claw options method of control as taught by the present invention; and

FIG. 37 is a flow chart illustrating the sound option method of control as taught by the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Now referring to the Figures, an embodiment of the Crane Controller PCB is shown. In the current state of the prior art the owner of a machine must manually set up the proper strength of the claw to have the game play properly.

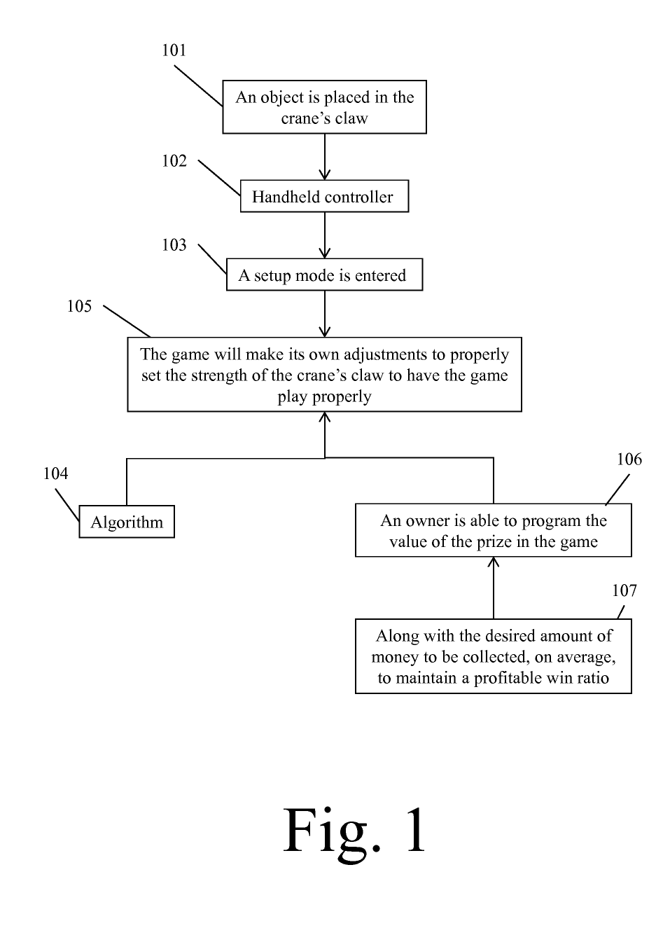

Now referring to FIG. 1, the present invention teaches a method that set up the proper strength of the claw to have the game play properly. In a first step an object is placed in the crane's claw 101 and then, via a handheld controller 102, a setup mode is entered 103. The game will then proceed to, based on an algorithm 104, make its own adjustments to properly set the strength of the crane's claw to have the game play properly 105. An owner is able to program the value of the prize in the game 106 along with the desired amount of money to be collected, on average, to maintain a profitable win ratio 107.

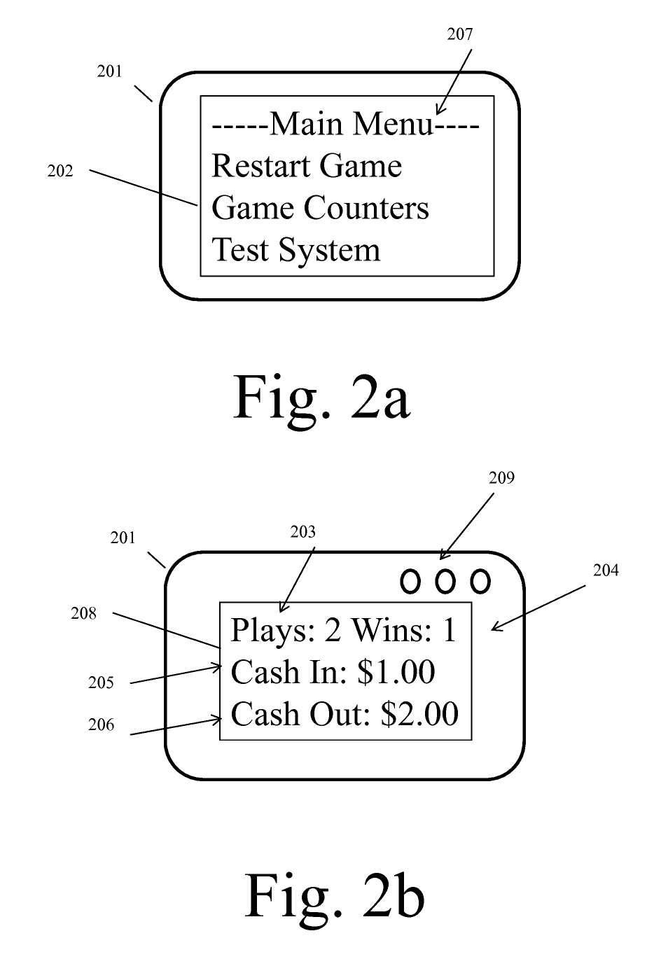

Now referring to 2a, the controller 201 and illustrative display screen 202 are shown. From the main menu, a user can restart the game controller, view the game counters, or test the PCB system. FIG. 2b illustrates the controller with the game counter title screen 208 of the controller 201 shown. The game counter title screen 208 displays the number of plays 203, winds 204, cash in 205, and cash out 206. Status LEDs 209 on the controller 201 are provided to assist in diagnostics and status of physical parts of the game itself.

The controller 201 shown in FIGS. 2a-2b provides a graphical user interface (GUI) for accessing the printed circuit board (PCB). The controller 201 is used to retrieve information from the controller PCB and to also program other information into it as well as perform diagnostics of the game and machine.

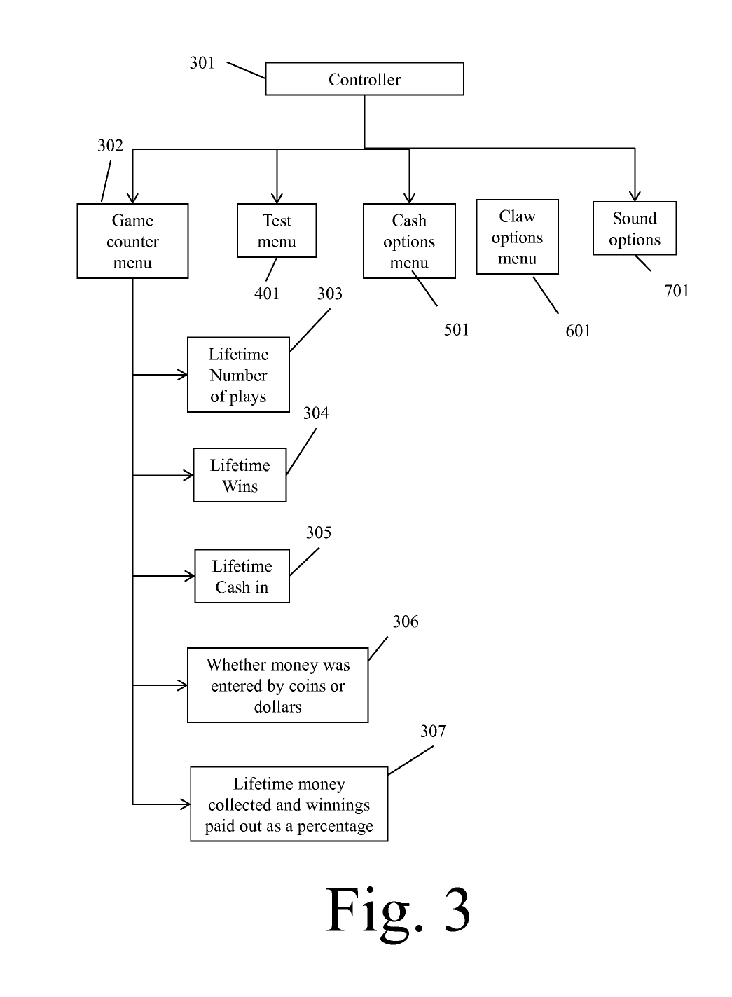

Now referring to FIG. 3, to use the controller, a user simply scrolls through the options by moving an arrow up and down by pressing a button or scroll wheel and making a selection as taught in the art for many controllers 301. Under the game counter menu 302, the user can view lifetime statistics such as number of plays 303, wins 304, and cash in 305 and whether money was entered by coins or dollars 306, and lifetime money collected and winnings paid out as a percentage 307.

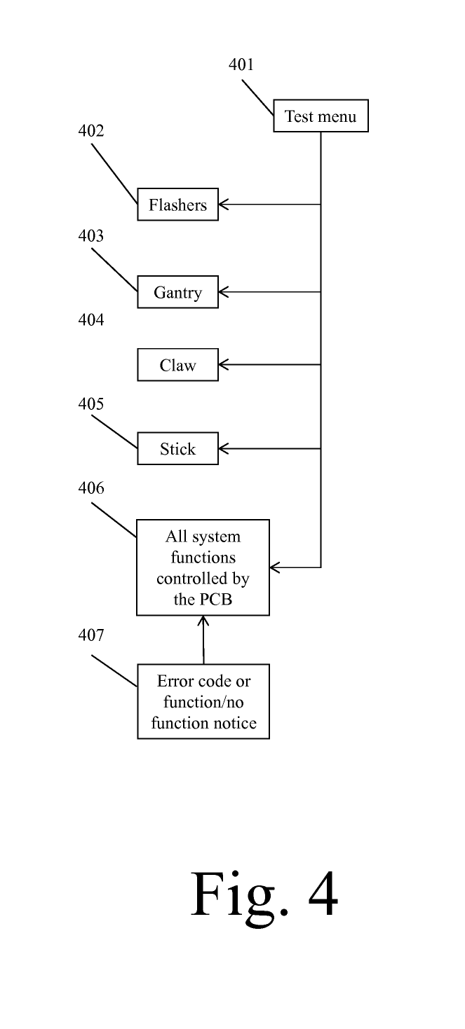

Now referring to FIG. 4, from a test menu 401, the user can test the flashers 402, gantry 403, claw 404, and stick 405, or all system functions controlled by the PCB 406. The system returns can return either an error code or function/no function notice 407.

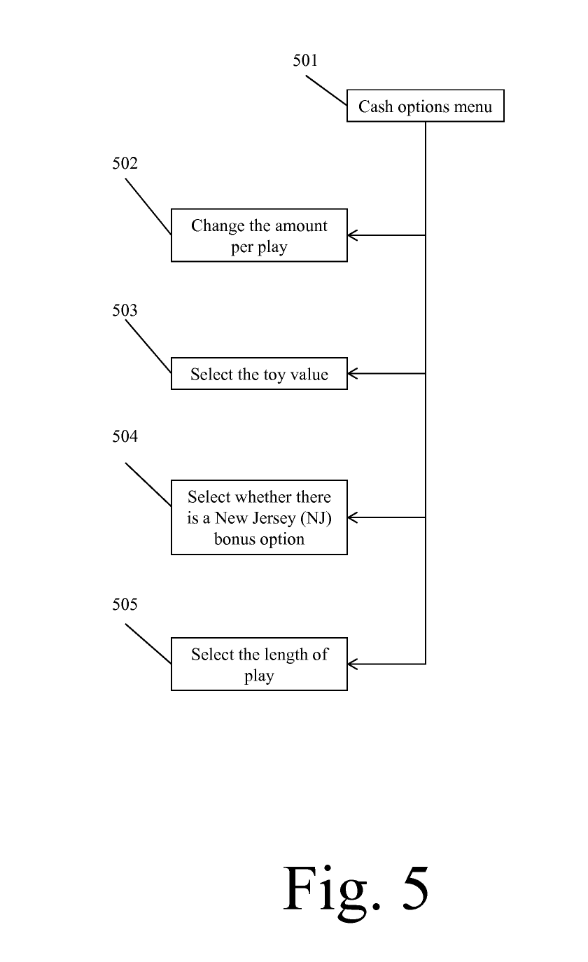

Now referring to FIG. 5, the cash options 506 flow is illustrated. When the cash options menu 501 is selected a user can change the amount per play 502, the toy value 503, select whether there is a New Jersey (NJ) bonus option 504, and the length of play 505.

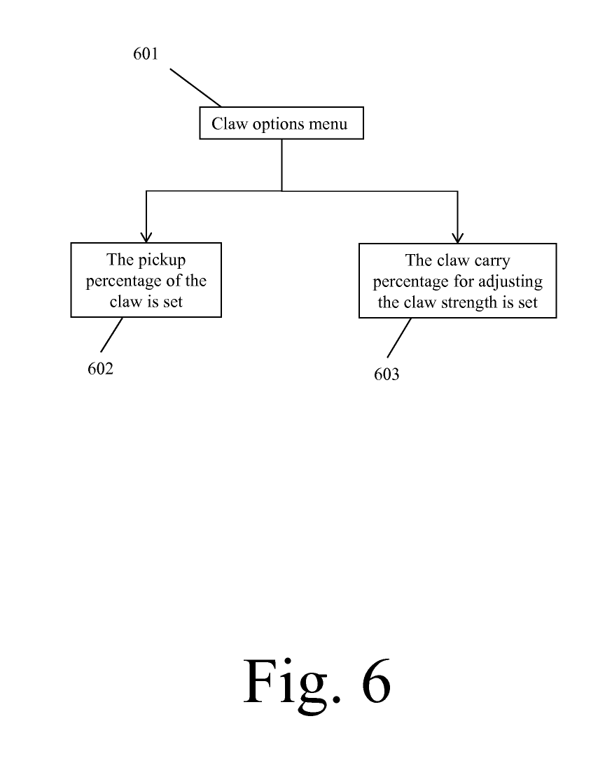

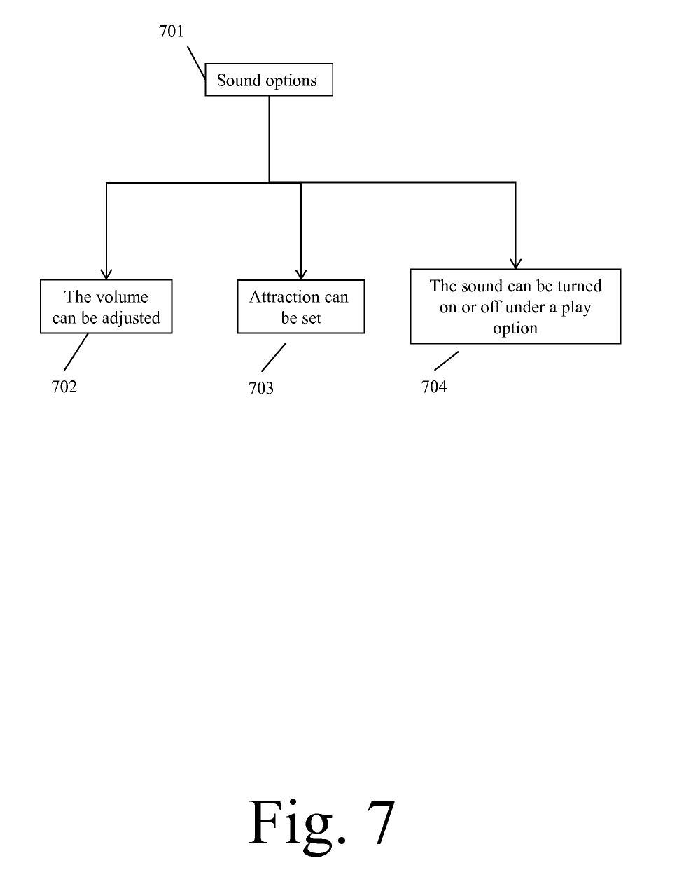

Now referring to FIG. 6, the claw options menu 601 flow is illustrated. In this menu the pickup percentage of the claw is set 602 as well as the claw carry percentage 603 for adjusting the claw strength.

Now referring to FIG. 7, the sound options 701 menu flow is illustrated. Under the sound options 701 the volume 702 can be adjusted, attraction 703 can be set, and the sound can be turned on or off under a play option 704.

Using the controller and PCB, the claw crane machine can be programmed so that the prize cost is $1.00 and that it is desired to collect $5.00 in play, on average, before a prize is won. The game, via the PCB, will keep track of these numbers and adjust itself and the crane's claw, to make it weaker or stronger in a random fashion, to maintain these values as a percentage.

Other features: an adjustable price per play from 0.25-$100.00; the ability to set a bonus play as per NJ LCGGG laws as discussed in FIG. 5 include; the ability to adjustable play per credit; the ability to keep track of money in and prizes out; and provide digital music for game play via a SD memory card attached to and accessed by the PCB.

In another embodiment, remote access to the controller via the Internet is taught. The controller is equipped with a wireless access point to allow a user to remotely, over the Internet, access and control all of the same functions as from the controller GUI from a PC, BLACKBERRY, IPHONE device, or other electronic device with Internet access.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for controlling a crane machine comprising:
providing a PCB with a memory;
accessing the PCB from a controller;
retrieving information from the PCB memory;
programming information into the PCB;
performing diagnostics of the game and machine via the PCB;
establishing a setup mode using the PCB;
making adjustments, based on an algorithm, to properly set the strength of the crane's claw to have the game play properly.

2. The method of claim 1, wherein, based on an algorithm, the PCB makes its own adjustments to set the strength of the crane's claw.

3. The method of claim 1 further comprising:
equipping the controller with a wireless access point to allow the owner to remotely to access and control the functions.

4. The method of claim 1 further comprising:
providing remote access to the controller via the Internet.

5. The method of claim 4 wherein access is provided by any mobile electronic device with an Internet connection.

6. The method of claim 1 further comprising:
programming the value of the prize in the game along with the desired amount of money to be collected, on average, to maintain a profitable win ratio.

6. The method of claim 1 further comprising
status LEDs on the controller to assist in diagnostics and status of physical parts of the game itself.

7. The method of claim 1 further comprising
a Hand Held Controller Wand providing a graphical user interface (GUI) for accessing the printed circuit board (PCB);
the Hand Held Controller Wand is used to retrieve information from the controller PCB and to program other information into it as well as perform diagnostics of the game and machine.

8. The method of claim 1 further comprising the steps of:
programming the value of the prize in the game along with the desired amount of money to be collected, on average, to maintain a profitable win ratio; and
adjusting the crane's claw, to make it weaker or stronger in a random fashion, to maintain these values as a percentage.

9. The method of claim 1 further comprising the steps of:
providing adjustable price per play;
providing the ability to set a bonus play;
providing the ability to adjustable play per credit;
providing the ability to keep track of money in and prizes out; and
providing digital music for game play via a SD memory card attached to and accessed by the PCB.

10. A crane controller PCB device comprising:
a PCB with a memory;
a controller,
accessing the PCB memory;
retrieving information from the PCB memory;
programming information into the PCB memory;
performing diagnostics of the game and machine via the PCB;
establishing a setup mode using the PCB; and making adjustments, based on an algorithm, to properly set the strength of the crane's claw to have the game play properly.

11. The device of claim 10, wherein, based on an algorithm, the PCB makes its own adjustments to set the strength of the crane's claw.

12. The device of claim 10 further comprising a wireless access point connected to the controller allowing remote access and control the functions.

13. The device of claim 12 wherein the wireless access point provides remote access to the controller via the Internet.

14. The device of claim 13 wherein the wireless access point provides remote access to the controller by any mobile electronic device with an Internet connection.

15. The device of claim 10 further comprising:
programming information into the PCB memory, wherein programming the value of the prize in the game along with the desired amount of money to be collected, on average, to maintain a profitable win ratio.

16. The device of claim 10 further comprising one or more status LEDs on the controller to assist in diagnostics and status of physical parts of the game itself.

17. The device of claim 10 further comprising:
a Hand Held Controller Wand providing a graphical user interface (GUI) for accessing the printed circuit board (PCB).

18. The device of claim 10 further comprising means for adjusting the crane's claw, to make it weaker or stronger in a random fashion, to maintain these values as a percentage.

19. The device of claim 10 further comprising a SD memory card attached to and accessed by the PCB providing digital music for game play.
